(19) United States
(12) Patent Application Publication
(10) Pub. No.: US 2012/0054377 A1
(43) Pub. Date: Mar. 1, 2012

(54) METHOD, APPARATUS AND SYSTEM FOR MANAGING LINE BETWEEN ACCESS DEVICE AND TERMINAL

(75) Inventors: Raphael Cendrillon, Palo Alto, CA (US); Jianping Tu, Shenzhen (CN)

(73) Assignee: Huawei Technologies Co., Ltd., Shenzhen (CN)

(21) Appl. No.: 13/290,600

(22) Filed: Nov. 7, 2011

Related U.S. Application Data
(63) Continuation of application No. PCT/CN2009/071715, filed on May 8, 2009.

(51) Int. Cl. G06F 3/00

(52) U.S. Cl. 710/18; 710/15

(57) ABSTRACT

The present invention provides a method, an apparatus and a system for managing a line between an access device and a terminal, where the provided method includes: receiving, by an access device, a port number, an event set and a collection period delivered by RDC; judging, according to the collection period, whether an event in the event set occurs to lines corresponding to the port number; if an event in the event set occurs to one or more of the corresponding lines, saving the corresponding port number, the event that occurs and a time when the event occurs; and uploading, according to a preset uploading number, the port number, the event that occurs and the time when the event occurs that are saved to the RDC, which are further uploaded to a line management center by the RDC for an analysis to identify positions of the lines.

### CROSS-REFERENCE TO RELATED APPLICATIONS

This application is a continuation of International Application No. PCT/CN2009/071715, filed on May 8, 2009, which is hereby incorporated by reference in its entirety.

### FIELD OF THE INVENTION

The present invention relates to the communication field, and in particular, to a method, an apparatus and a system for managing a line between an access device and a terminal.

### BACKGROUND OF THE INVENTION

With the rapid increase of demands of broadband subscribers on services, especially the increase of demands on the triple play service, the number of digital subscriber line (DSL) subscriber lines increases rapidly. How to maintain the current huge number of DSL lines to ensure high-quality operation of the access service becomes extremely important. The emergence of a line management system makes the high-quality access service possible. What the high-quality access service mainly needs to achieve includes high-speed data transmission, steady service effect and rapid fault diagnosis.

A subscriber cable basically includes a plurality of pairs (for example, 25 pairs or more) of twisted-pair cables, on which a variety of different services may operate. When these different services are operating at the same time, crosstalk may be generated among each other, and as a result, performance of some lines declines dramatically. When the lines are relatively long, some of the lines cannot open any form of digital subscriber line (DSL) services, and therefore, the lines need to be optimized.

A data bit rate and the stability of the lines can be increased by optimizing the lines, and specific implementation technologies includes: dynamic line management (DLM), dynamic rate management (DRM), dynamic spectrum management (DSM), and virtual noise (VN).

Line fault diagnosis is to judge a fault of a line according to an operation state and an operation parameter of the line.

To accomplish the line optimization or the line diagnosis, an operating environment of the line must be known. After the operating environment of the line is known, if lines surrounding a certain line generate crosstalk to the line, we may decrease influence of the crosstalk from the surrounding lines on the line by controlling a transmit power of the surrounding lines, or diagnose the faults of the line according to some faults shared by the surrounding lines; for example, if the surrounding lines all suffer from the impulse noise protection (INP) fault, judge that the line also suffers from the INP fault.

However, actual line conditions are very complex. On a distribution frame disposed in a central office, lines corresponding to adjacent ports may not be disposed in a same bundle of lines, while lines corresponding to non-adjacent ports may be disposed in a same bundle of lines, and the DSM optimization just needs to be performed on lines in a same bundle of lines. Currently, there are millions of ports on the network, and the line management system has to know lines corresponding to which of the ports belong to a same bundle of lines. Only in this way can the DSM optimization be performed. According to the solution currently available, the central office provides topological information of lines. However, the topological information from the central office sometimes is not very accurate, and when a change occurs to the lines, the information database of the central office cannot always be updated in time.

### SUMMARY OF THE INVENTION

Embodiments of the present invention provide a method, an apparatus and a system for managing a line between an access device and a terminal, which are intended to identify that which lines exist in a same bundle of lines.

An embodiment of the present invention provides a method for managing a line between an access device and a terminal, including:

obtaining, by the access device, a port number, an event set and a collection period;

judging, by the access device, according to the collection period, whether an event in the event set occurs to lines corresponding to the port number, and if the event in the event set occurs to one or more of the lines corresponding to the port number, saving the corresponding port number, the event that occurs, and a time when the event occurs; and

transmitting, by the access device, the port number, event that occurs and time when the event occurs that are saved to a line management center to identify positions of the lines corresponding to the port number.

An embodiment of the present invention provides a method for managing a line between an access device and a terminal, including:

transmitting a port number, an event set and a collection period to the access device, where the collection period is used to instruct the access device to judge, according to the collection period, whether an event in the event set occurs to lines corresponding to the port number;

receiving the event that occurs, a time when the event occurs and the port number corresponding to the lines where the event occurs transmitted by the access device, where the event that occurs is included in the event set; and

making an analysis according to the port number, the event that occurs and the time when the event occurs transmitted by the access device, so as to identify positions of the lines corresponding to the port number.

An embodiment of the present invention provides an access device, including:

a receiving unit, configured to obtain a port number, an event set, and a collection period;

a data collection unit, configured to collect data on lines corresponding to the port number according to the collection period;

a management unit, configured to judge, according to data collected by the data collector, whether an event in the event set occurs to the lines corresponding to the port number, and if the event in the event set occurs to one or more of the lines corresponding to the port number, notify the data collection unit of saving the event that occurs, a time when the event occurs and the port number corresponding to the event into a storage unit;

the storage unit, configured to save the event that occurs, the time when the event occurs, and the port number corresponding to the event from the data collection unit; and

a transmitting unit, configured to transmit the event that occurs, the time when the event occurs, and the port number corresponding to the event that are saved in the storage unit to a line management center to identify positions of the lines corresponding to the port number.

An embodiment of the present invention provides a line management center, including:

a receiving unit, configured to receive a port number, an event that occurs and a time when the event occurs uploaded by a remote data collector (RDC), and store the port number, the event that occurs, and the time when the event occurs into a storage unit;

the storage unit, configured to store the port number, the event that occurs, and the time when the event occurs that are received by the receiving unit; and

a processing unit, configured to make an analysis on the port number, the event that occurs, and the time when the event occurs that are stored in the storage unit, so as to identify positions of lines corresponding to the port number.

An embodiment of the present invention provides a system for managing a line between an access device and a terminal, including:

the access device, configured to: receive a port number, an event set, and a collection period from a line management center; judge, according to the collection period, whether an event in the event set occurs to lines corresponding to the port number; and if the event in the event set occurs to one or more of the lines corresponding to the port number, save the event that occurs, a time when the event occurs, and the port number corresponding to the event, and upload the event that occurs, the time when the event occurs, and the port number corresponding to the event that are saved to the line management center; and

a line management center, configured to identify positions of the lines corresponding to the port number according to the event that occurs, the time when the event occurs, and the port number corresponding to the event uploaded by the access device.

According to the method, the apparatus, and the system for managing a line between an access device and a terminal provided by the present invention, the number of times of correlated event among lines is obtained through collection and analysis on the line events. When the number of times of the correlated event reaches a preset value, it may be considered that the two pairs of lines exist in a same bundle of lines. The process has advantages such as high accuracy, low complexity in implementation, and small space occupation.

### BRIEF DESCRIPTION OF THE DRAWINGS

FIG. 1 is a schematic diagram of a system for managing a line between an access device and a terminal according to an embodiment of the present invention;

FIG. 2 is a schematic structure diagram of an access device according to an embodiment of the present invention;

FIG. 3 is a schematic structure diagram of a line management center according to an embodiment of the present invention; and

FIG. 4 is a flow chart of a method for managing a line between an access device and a terminal according to the present invention.

### DETAILED DESCRIPTION OF THE EMBODIMENTS

The following illustrates the present invention clearly and completely with reference to the accompanying drawings.

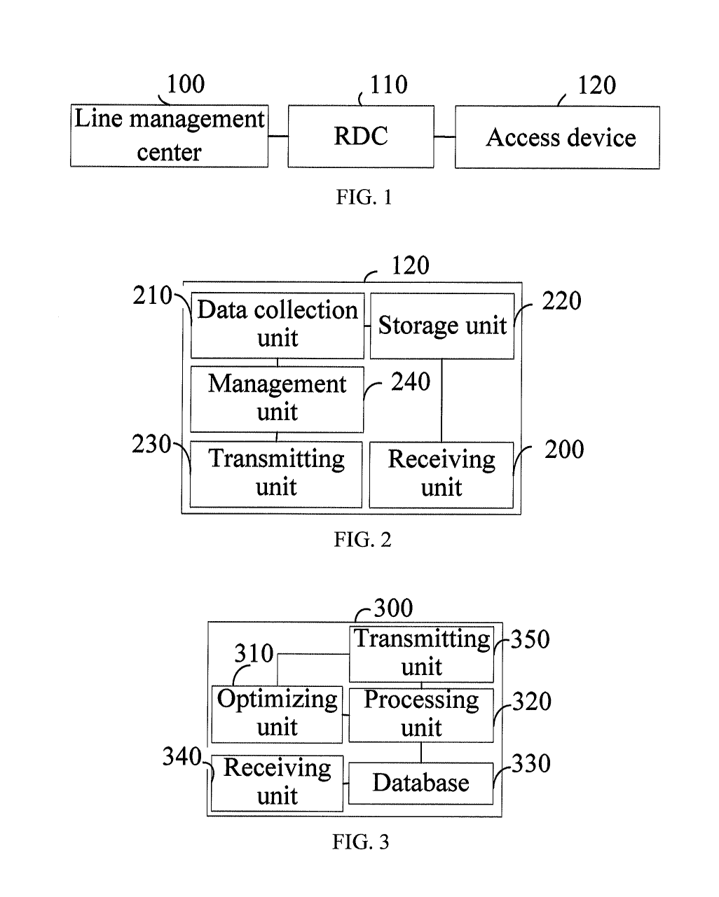

An embodiment of the present invention provides a management system for managing a line between an access device and a terminal, which is intended to identify that which lines are in a same bundle of lines. As shown in FIG. 1, the provided system includes a line management center 100, a remote data collector RDC 110 and an access device 120, where the access device 120 may be a digital subscriber line access multiplexer (DSLAM).

The remote data collector RDC 110 is configured to deliver a port number, where the port is one from which data need to be collected, an event set that needs to be monitored, and a collection period of the data collection to the DSLAM 120 through the simple network management protocol (SNMP).

The port number is the number of a port on the access device 120, and each port is connected to one line, that is, each port number corresponds to a pair of lines. The port number, the event set that needs to be monitored, and the collection period of the data collection that are delivered may be stored in three frames respectively, with one of the frames saving the port number, one saving the event set and the other saving the collection period.

The event set that needs to be monitored includes at least one of line activation, line deactivation, rise of a bit (or code) error rate, generation of an impulse noise protection (INP), generation of SOS, an alarm indication defined in G997.1 (for example, an alarm of the signal loss), pre-warning information defined in G997.1 (for example, the forward error correction (FEC) below a preset threshold), fall of a performance monitoring parameter below a preset threshold (for example, fall of a signal noise ratio (SNR) below 3 dB), fall of a bit rate, and any other event associated with the performance. The content of the event set delivered by the DRC 110 to the access device 120 depends on the capability of the access device 120.

The collection period of the data collection is a period at which the access device 120 performs the data collection. If the data collection period delivered by the RDC 110 is 15 minutes, the access device 120 performs a round of the data collection on lines corresponding to the port number every 15 minutes.

The RDC 110 is further configured to receive the port number, an event that occurs, and a time when the event occurs uploaded by the access device 120, and upload the port number, the event that occurs, and the time when the event occurs uploaded by the access device 120 to the line management center 100 through text transfer protocol FTP/TFTP/SFTP/HTTP or the like according to a preset period.

The access device 120 is configured to perform the data collection on the lines corresponding to the port number according to the data collection period delivered by the RDC 110; later, make an analysis on the collected data; and if an event, like line activation, in the event set occurs to some of the lines, record the port number corresponding to the lines, the event that occurs, and a time when the event occurs; and for example, make an analysis on the collected data of a certain line, if the SNR value fall of the line exceeds a preset threshold, it is considered that the event that the performance monitoring parameter falls below a preset threshold occurs to the line, and the access device 120 saves the port number corresponding to the line, the event that occurs, and a time when the event occurs.

The access device 120 may also collect data of other lines where a specific event occurs when receiving alarm information transmitted by the line, and save port number corresponding to these lines, the event that occurs, and a time when the event occurs. The specific event is included in the event set delivered by the RDC.

The access device 120 is further configured to upload the port number, the event that occurs and the time when the event occurs that are saved to the RDC 110 through SNMP or FTP/TFTP/SFTP/HTTP. Specifically, the access device 120 may upload the port number, the event that occurs and the time when the event occurs that are saved to the RDC 110 according to a preset uploading period.

The line management center 100 is adapted to configure an alarm template and a threshold of a performance monitoring parameter, and deliver the alarm template and the threshold of the performance monitoring parameter that are configured, to the access device 120, where the alarm template is a reference standard for the access device 120 to judge whether an alarming event occurs. After collecting operation parameter of the line, the access device 120 matches the operation parameter with set data in the alarm template. If the operation parameter and the set data are matched, the access device 120 considers that the corresponding alarming event occurs to the line. The performance monitoring parameter includes the signal noise ratio (SNR) and/or the bit rate.

The line management center 100 is further configured to deliver the port number, the event set, and the collection period to the RDC.

The line management center 100 may actively collect, according to the needs of statistics and analysis, the port number, the event that occurs, and the time when the event occurs that are saved from the RDC 110.

The line management center 100 is further configured to make an analysis on the port number, the event that occurs, and the time when the event occurs uploaded by the RDC 110, and make statistics on the number of times of correlated event between every two pairs of lines within a preset time interval (for example, 3 minutes). If the number of times of correlated event between every two pairs of lines reaches a preset threshold, it is judged that the two pairs of lines are disposed in a same bundle of lines. A correlation relationship among events is set on the line management center 100. For example, within a preset time interval, line activation and fall of the bit rate below a preset threshold form a correlated event; and the line activation and an alarm of the signal loss form a correlated event. The line management center 100 makes statistics on the number of times of correlated event among the lines within the preset time interval according to the correlated event relationships. For example, suppose that the time interval for correlated event between every two pairs of lines is 3 minutes, and the line management center 100 makes an analysis on the saved data and determines that the event of line activation occurs to one pair of the lines at 17:00 on Jan. 1, 2000 and rise of the bit (or code) error rate occurs to another pair of the lines at 17:01 on Jan. 1, 2000. According to the correlated event relationships, the line activation and the rise of the cyclic redundancy check form a correlated event. Therefore, the line management center 100 increases the number of times of correlated event on these two pairs of the lines by 1. After making statistics for many times, if the number of times of correlated event on these two pairs of the lines reaches a preset threshold (for example, 7 times), it may be considered that these two pairs of the lines are disposed in a same bundle of lines.

The RDC 110 provided by this embodiment may be independent of the access device 120, or disposed in the access device 120.

The system for managing a line between an access device and a terminal provided by this embodiment obtains the number of times of correlated event among the lines through collection, statistics and analysis on the events that occur to the lines, and thereby judges whether two lines are disposed in a same bundle of lines according to the number of times of correlated event. The system has the advantages of low complexity in implementation and small space occupation.

An embodiment of the present invention provides an access device. As shown in FIG. 2, the provided access device 120 includes a receiving unit 200, a data collection unit 210, a storage unit 220, a transmitting unit 230, and a management unit 240.

The receiving unit 200 is configured to receive an alarm template and a threshold of a performance parameter that are delivered by the line management center, and receive a port number, an event set and a collection period that are delivered by the RDC.

The receiving unit 200 receives, through the SNMP, the port number, the event set, and the collection period that are delivered by the RDC. Each port number corresponds to a pair of lines. The event set includes at least one of line activation, line deactivation, rise of a bit (or code) error rate, generation of INP, generation of an SOS, an alarm indication defined in G997.1 (for example, an alarm of the signal loss), pre-warning information defined in G997.1 (for example, a forward error correction (FEC) below a preset threshold), fall of a performance monitoring parameter below a preset threshold (for example, fall of a signal noise ratio (SNR) below 3 dB), fall of a bit rate, and any other event associated with the performance.

The data collection unit 210 is configured to collect data on lines corresponding to the port number according to the collection period received by the receiving unit 200.

The data collection unit 210 collects data on the lines corresponding to the port number periodically according to the collection period.

The management unit 240 is configured to judge whether an event in the event set occurs to the lines corresponding to the port number according to data collected by the data collection unit, and if the event in the event set occurs to one or more of the lines corresponding to the port number, notify the data collection unit of saving the corresponding port number and a time when the event occurs into the storage unit.

The management unit 240 makes an analysis on the data collected by the data collection unit 210, and if the analysis result shows that the event of line activation or line deactivation or fall of the performance monitoring parameter below a preset threshold occurs to a certain pair of lines, considers that an event in the event set occurs to the line and notifies the data collection unit 210 of recording and saving the port number corresponding to the line, a name of the event, and a time when the event occurs into the storage unit 220.

In another embodiment of the access device 120, when the data collection unit 210 receives an alarming event reported by a certain line, the management unit 240 notifies the data collection unit 210 of collecting information of other lines where an event in the event set occurs, and notifies the data collection unit 210 of saving corresponding port number, the event that occurs, and a time when the event occurs into the storage unit 220.

The storage unit 220 is configured to receive the port number, the name of the event and the time when the event occurs from the data collection unit 210.

The transmitting unit 230 is configured to upload the port number, the name of the event and the time when the event occurs that are saved in the storage unit 220 to the RDC according to a preset uploading period.

The transmitting unit 230 uploads the port number, the name of the event, and the time when the event occurs that are saved in the storage unit 220 to the RDC according to an preset uploading period (for example, one day).

The RDC uploads the data uploaded by the transmitting unit 230 to the line management center periodically (for example, every other week), and the line management center makes statistics and analysis on these data, thereby obtaining that which lines are disposed in a same bundle of lines.

The access device 250 provided by this embodiment may be a DSLAM.

The access device provided by this embodiment monitors lines according to the event set delivered by the RDC, and when an event in the event set occurs to a line, saves a port number corresponding to the line and a time when the event occurs, and uploads the port number corresponding to the line and the time when the event occurs to the RDC within a preset time interval. Thereby, the RDC uploads these data to the line management center for statistics and analysis to obtain that which lines are disposed in a same bundle of lines.

An embodiment of the present invention provides a line management center. As shown in FIG. 3, the line management center 300 includes an optimizing unit 310, a processing unit 320, a receiving unit 340, a storage unit 330, and a transmitting unit 350, where the optimizing unit 310 may includes a DSM optimizing module, a DLM optimizing module, or the like.

The optimizing unit 310 is configured to generate an optimizing template according to an optimization algorithm.

The receiving unit 340 is configured to receive data transmitted by the RDC, including port number, an event that occurs and a time when the event occurs, and store these received data into the storage unit 330.

The storage unit 330 is configured to store the port number, the event that occurs, and the time when the event occurs that are received by the receiving unit 340.

The processing unit 320 is configured to make statistics and analysis on the port number, the event that occurs, and the time when the event occurs that are saved by the storage unit 330, thereby obtaining positions of the lines corresponding to the port number.

The processing unit 320 includes a counter, where the counter is configured to make statistics on the number of times of correlated event. When a specific event occurs to a certain line, for example, line activation occurs, if a specific event occurs to another pair of lines within a preset time interval (for example, 3 minutes), for example, fall of the performance monitoring parameter below a preset threshold, the counter increases the number of times of correlated event by 1. In this way, the processing unit 320 makes an analysis on the data that are saved in the storage unit 330. When the number of times of correlated event on two pairs of the lines reaches a preset threshold, the processing unit 320 judges that the two line pairs are disposed in a same bundle of lines.

The processing unit 320 is further configured to transmit line position information obtained through the statistics and analysis to the optimizing unit 310, so that the optimizing unit 310 generates an optimizing module according to the line position information.

The processing unit 320 is further adapted to configure an alarm template and a threshold of the performance monitoring parameter, and transmit the alarm template and the threshold of the performance monitoring parameter to the access device via the transmitting unit 350.

The transmitting unit 350 is configured to deliver the optimizing module generated by the optimizing unit 310 to the access device.

The transmitting unit 350 may further actively transmit a command message of uploading port number, an event that occurs and a time when the event occurs to the RDC.

The line management center provided by this embodiment can make statistics and analysis on the data uploaded by the RDC to obtain the number of times of correlated event, and judges, according to the number of times of correlated event, that which lines are disposed in a same bundle of lines. The line management center has the advantages of high accuracy and low complexity.

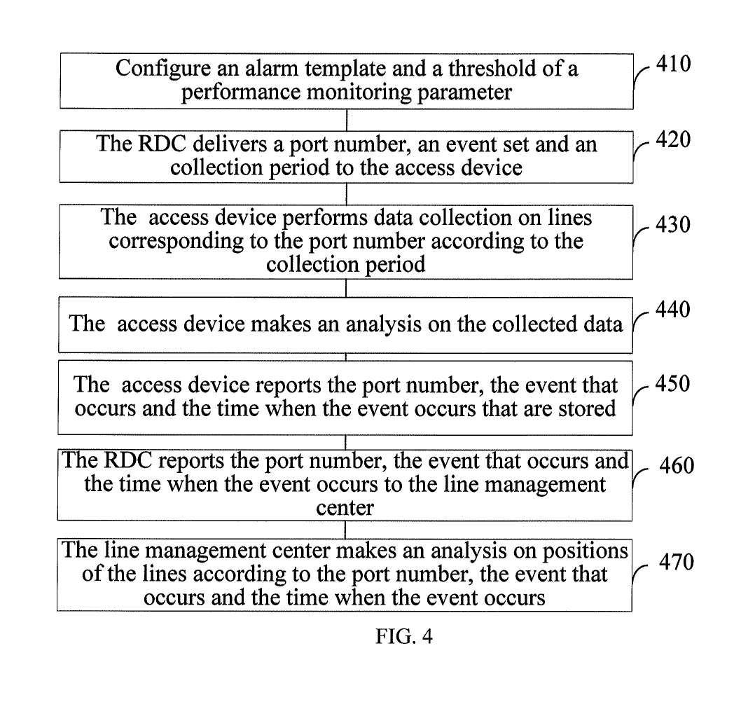

An embodiment of the present invention provides a method for managing a line between an access device and a terminal, where the method can judge that which lines are disposed in a same bundle of lines. As shown in FIG. 4, the method includes:

Step 410: Configure an alarm template and a threshold of the performance monitoring parameter.

After configuring the alarm template and the threshold of the performance monitoring parameter, the line management center delivers the alarm template and the threshold of the performance monitoring parameter that are configured to a corresponding access device. The threshold of the performance monitoring parameter includes a threshold of fall of the SNR and/or a threshold of fall of the bit rate, and the access device may be a DSLAM.

The alarm template and the threshold of the performance monitoring parameter may also be configured on the access device by a user.

Step 420: Deliver a port number, an event set, and a collection period to the access device by the RDC.

The RDC saves the port number through which a service is opened on the access device and a capability attribute of the access device, where the capability attribute of the access device includes an event that can be monitored by the access device.

The RDC delivers a port number that need to be monitored, an event set that can be monitored by the access device, and a collection period at which the access device performs data collection to the access device, where the event set includes:

at least one of: line activation, line deactivation, rise of bit (or code) error rate, rise of FEC number, occurrence of an INP, occurrence of an SOS, line re-initialization, fall of an SNR, fall of a bit rate, an alarm indication defined in G997.1, pre-warning information defined in G997.1, and any other event associated with the performance.

The content of the event set depends on the capability of the access device. For example, if some access devices cannot monitor the pre-warning information defined in G997.1, the event set delivered by the RDC does not include the pre-warning information defined in G997.1.

The collection period is a period at which the access device performs data collection on lines corresponding to the port number.

Step 430: The access device performs data collection on lines corresponding to the port number according to the collection period.

The access device performs data collection on the lines corresponding to the port number delivered by the RDC according to the collection period, and the collected information includes a bit rate and so on.

The access device may also, after the alarm information is reported by the line, collect information of other lines where a specific event occurs and save corresponding port number, the event that occurs, and a time when the event occurs.

Step 440: The access device makes an analysis on the collected data.

The access device makes an analysis on the collected data, judges whether an event such as line activation, line deactivation, occurrence of alarm information, occurrence of pre-warning information, or fall of the performance monitoring parameter below a preset threshold occurs to the corresponding lines, and if one or more of these events occurs, records the port number corresponding to the lines, the event(s) that occur(s) and a time when the event(s) occur(s).

If the RDC fails to deliver the event set to the access device in step 420, the access device makes an analysis according to the collected data to judge whether an event that can be monitored by the access device occurs to the corresponding lines. If the event occurs, the access device records the port number corresponding to the lines and a time when the event occurs.

Step 450: The access device reports the port number, the event that occurs, and the time when the event occurs that are stored.

After a time period of collection, the access device uploads the port number, the event that occurs and the time when the event occurs that are saved to the RDC according to a preset period.

Step 460: The RDC reports the port number and the time when the event occurs to the line management center.

After a time period (a preset time interval), the RDC reports the port number, the event that occurs, and the time when the event occurs that are saved to the line management center.

Step 470: A line management center makes an analysis on positions of the lines according to the port number, the event that occurs, and the time when the event occurs.

After a relatively long time period of collection, the line management center makes an analysis on the port number, the event that occurs, and the time when the event occurs, so as to make statistics on the number of times of correlated event.

According to that after a specific event occurs to a certain line in a same bundle of lines, fall of the performance and stability occur to the other lines in the same bundle of lines within a certain time interval, the line management center judges whether a correlated event exists among lines. However, it cannot be simply determined that two pairs of the lines are disposed in a same bundle of lines according to only one occurrence of this phenomenon. A threshold may be set for the number of times of correlated event. When the number of times of correlated event on two pairs of the lines reaches the preset threshold, it may be considered that the two pairs of the lines are disposed in a same bundle of lines.

For example, a time interval of correlated event is set to be 3 minutes. If an event of line activation occurs to a certain pair of lines A at 17:00 on Jan. 1, 2000 and fall of the bit rate below a preset threshold occurs to another pair of lines B at 17:02 on Jan. 1, 2000, the number of times of correlated event of A and B is increased by 1. If an event of line deactivation occurs to the line A at 17:00 on Jan. 2, 2000 and rise of the signal to noise ratio occurs to the line B at 17:01 on Jan. 2, 2000, the number of times of correlated event of the line A and the line B is further increased by 1. Statistics is also made among other lines in the same way. When the number of times of correlated event of the line A and the line B reaches a preset value (for example, 7 times), it may be considered that the line A and the line B belong to a same bundle of lines.

According to the method for managing a line between an access device and a terminal provided by this embodiment, by collecting the time when the event occurs to the line, statistics is made on the number of times of correlated event. When the number of times of correlated event reaches a preset threshold, it may be judged that the corresponding two pairs of lines exist in a same bundle of lines. In the whole process, the judgment result has the advantages of high accuracy and low complexity. By setting a threshold for a corresponding event, only an event that exceeds the threshold is saved. Therefore, the space that is needed to save data is small.

What disclosed above are merely several specific embodiments of the present invention. However, the present invention is not limited thereto, and any modifications that can occur to those skilled in the art should fall within the scope of the present invention.

1. A method for managing a line between an access device and a terminal, comprising:
obtaining, by the access device, a port number, an event set, and a collection period;
judging, by the access device, according to the collection period, whether an event in the event set occurs to lines corresponding to the port number, and if the event in the event set occurs to one or more of the lines corresponding to the port number, saving the corresponding port number, the event that occurs, and a time when the event occurs; and
transmitting, by the access device, the port number, the event that occurs, and the time when the event occurs that are saved to a line management center to identify positions of the lines corresponding to the port number.

2. The method according to claim 1, wherein:
the obtaining, by the access device, a port number, an event set, and a collection period by the access device comprises: obtaining, by the access device, the port number, the event set, and the collection period via a remote data collector (RDC) connected to the access device; and
the transmitting, by the access device, the port number, the event that occurs and the time when the event occurs that are saved to the line management center comprises: transmitting, by the access device, the port number, the event that occurs, and the time when the event occurs that are saved to the line management center via the RDC connected to the access device.

3. The method according to claim 2, wherein:
the access device transmits the port number, the event that occurs, and the time when the event occurs that are saved to the RDC connected to the access device according to a period T1, wherein the RDC transmits the port number, the event that occurs, and the time when the event occurs from the access device to the line management center according to a period T2; and the period T1 is shorter than the period T2.

4. The method according to claim 1, wherein: before the obtaining a port number, an event set, and a collection period by the access device, further comprises: obtaining, by the access device, an alarm template and a threshold of a performance monitoring parameter provided by the line management center by the access device, wherein the alarm template is a standard for the access device to judge whether an alarm indication occurs.

5. The method according to claim 1, wherein the event set comprises at least one of line activation, line deactivation, rise of a bit error rate, an alarm indication, pre-warning information, fall of a performance monitoring parameter below a preset threshold, and fall of a line bit rate.

6. The method according to claim 3, wherein the event set comprises at least one of line activation, line deactivation, rise of a bit error rate, an alarm indication, pre-warning information, fall of a performance monitoring parameter below a preset threshold, and fall of a line bit rate.

7. An access device, comprising:
a receiving unit, configured to obtain a port number, an event set and a collection period;
a data collection unit, configured to collect data on lines corresponding to the port number according to the collection period;
a management unit, configured to judge whether an event in the event set occurs to the lines corresponding to the port number according to data collected by the data collection unit, and if the event in the event set occurs to one or more of the lines corresponding to the port number, notify the data collection unit of saving the event that occurs, a time when the event occurs, and the port number corresponding to the event into a storage unit;
the storage unit, configured to save the event that occurs, the time when the event occurs, and the port number corresponding to the event from the data collection unit; and
a transmitting unit, configured to transmit the event that occurs, the time when the event occurs, and the port number corresponding to the event that are saved in the storage unit to a line management center to identify positions of the lines corresponding to the port number.

8. The access device according to claim 7, wherein the receiving unit is further configured to receive an alarm template and a threshold of a performance monitoring parameter delivered by the line management center, and the alarm template is a standard for the access device to judge whether an alarm indication occurs.

9. The access device according to claim 7, wherein the access device exchanges data with the line management center via the remote data collector RDC, and wherein:
the receiving unit receives the port number, the event set, and the collection unit from the line management center via the RDC; and
the transmitting unit uploads the event that occurs, the time when the event occurs, and the port number corresponding to the event that are saved in the storage unit to the line management center via the RDC.

10. A line management center, comprising:
a transmitting unit, configured to transmit a port number, an event set, and a collection period to an access device;
a receiving unit, configured to receive an event that occurs to lines between the access device and a terminal, a time when the event occurs, and the port number corresponding to the event that are recorded by the access device, and store the event that occurs, the time when the event occurs, and the port number corresponding to the event into a storage unit;
the storage unit, configured to store the event that occurs, the time when the event occurs, and the port number corresponding to the event that are received by the receiving unit; and
a processing unit, configured to identify positions of the lines corresponding to the port number according to the event that occurs, the time when the event occurs, and the port number corresponding to the event that are stored in the storage unit.

11. A system for managing a line between an access device and a terminal, comprising:
the access device, configured to receive a port number, an event set, and a collection period from a line management center; judge whether an event in the event set occurs to lines corresponding to the port number according to the collection period; and if the event in the event set occurs to one or more of the lines corresponding to the port number, save the event that occurs, a time when the event occurs, and the port number corresponding to the event, and upload the event that occurs, the time when the event occurs, and the port number corresponding to the event to the line management center; and
the line management center, configured to identify positions of the lines corresponding to the port number according to the event that occurs, the time when the event occurs, and the port number corresponding to the event that are uploaded by the access device.

12. The system according to claim 11, wherein: the receiving, by the access device, port number, an event set, and a collection period from a line management center comprises: receiving, by the access device, the port number, the event set, and the collection period from the line management center via a remote data collector RDC connected to the line management center; and
the uploading, by the access device, according to a preset uploading period, the event that occurs, the time when the event occurs, and the port number corresponding to the event to the line management center comprises: uploading, by the access device, according to a preset uploading period, the event that occurs, the time when the event occurs, and the port number corresponding to the event that are saved, via the RDC connected to the line management center, to the line management center.

13. The system according to in claim 11, wherein: the making, by the line management center, an analysis on the port number and the time when the event occurs uploaded by the remote data collector RDC so as to identify the positions of the lines corresponding to the port number, which specifically comprises:
making, by the line management center, statistics on the number of times of correlated event in every two pairs of lines, and if the number of times of the correlated event in two pairs of the lines reaches a preset threshold, judging that the two line pairs are disposed in a same bundle of lines
